(19) United States
(12) Patent Application Publication
(10) Pub. No.: US 2016/0055440 A1
(43) Pub. Date: Feb. 25, 2016

(54) FLUCTUATION VALUE FORECASTING SYSTEM, STOCK MANAGEMENT SYSTEM, AND FLUCTUATION VALUE FORECASTING METHOD

(71) Applicant: R FIVE CORPORATION, Tokyo (JP)

(72) Inventor: Hideki KOMATSU, Tokyo (JP)

(21) Appl. No.: 14/680,470

(22) Filed: Apr. 7, 2015

(30) Foreign Application Priority Data
Aug. 22, 2014 (JP) 2014-169287

(51) Int. Cl. G06Q 10/06; G06Q 10/08; G06Q 10/04; G06N 99/00

(52) U.S. Cl. CPC G06Q 10/06315; G06N 99/005; G06Q 10/087; G06Q 10/04

(57) ABSTRACT

A fluctuation value forecasting system having a fluctuation value forecasting unit to output a future forecasting value from time series data of fluctuation values by using an ARIMA model, includes a first forecasting unit to have the fluctuation value forecasting unit calculate first forecasting values, by using multiple ARIMA models, respectively, the ARIMA models being determined by using the time series data; an index value calculation unit to calculate first and second index values, for each of the ARIMA models, by using the first forecasting values; a model selection unit to select an ARIMA model among the ARIMA models, based on the first and second index values; and a second forecasting unit to have the fluctuation value forecasting unit calculate a second forecasting value as the future forecasting value of the time series data, by using the selected ARIMA model.

### FIELD

The disclosures herein generally relate to a fluctuation value forecasting system, a stock management system, and a fluctuation value forecasting method.

### BACKGROUND

Conventionally, as a mathematical model derived from the heat conduction equation, the ARIMA (Auto-Regressive Integrated Moving Average) model has been known that is based on finite difference equations. The core part of the ARIMA model is represented by the following formula (1) where xₜ is a fluctuation quantity at timing t, φₙ and θₘ (n=1 to p, m=1 to q) are parameters, and Z is white noise having the variance σ².

xₜ=φ₁xₜ₋₁+ . . . +φₚxₜ₋ₚ+Zₜ+θ₁Zₜ₋₁+ . . . +θ_{q}Z_{t-q} (1)

Since a fluctuation quantity estimation method using an ARIMA model estimates the optimum parameters φₙ and θₘ, the degrees p and q, and the variance σ² by an approach method (a maximum likelihood method), a unique solution may not be obtained in contrast to, for example, a Black-Scholes equation. However, the method can exhibit excellent performance in fitting to actual results and/or followability to changes.

For such a fluctuation quantity estimation method using an ARIMA model, a technology has been known that improves precision in model selection, by selecting a model that has a least sum of a normalized value of a statistical information quantity, and a normalized value of an error index, among ARIMA models by degree patterns (see, for example, Patent Document 1).

Here, in Patent Document 1, a fluctuation quantity estimation method using an ARIMA model estimates (forecasts) a fluctuation quantity, by using data series having multiple data patterns, which are obtained, for example, by making difference series from time series data. Therefore, models are selected that correspond to the respective data series having the data patterns. Then, among these selected models, a model having the minimum error index is adopted as a forecasting model, and the method calculates a future forecasting value, by using this adopted forecasting model.

### RELATED-ART DOCUMENTS

### Patent Documents

### [Patent Document 1] Japanese Patent No. 4981976

In conventional management engineering or the like, a proper stock quantity is represented, for example, by the following formula (2) where D is the proper stock quantity, k is a safety coefficient, a is standard deviation, d is an average sales quantity, and m is a lead time.

D=k·σd·\sqrt{m} (2)

In this way, in the conventional management engineering or the like, the proper stock quantity is determined regardless of a future forecasting value that is calculated by a forecasting model. This is because precision of a forecasting value (forecasting precision) is not practically sufficient. However, it is desirable to determine a proper stock quantity based on a forecasting value, and further, to have the proper stock quantity be less than that conventionally obtained.

In view of the above, embodiments of the present invention have been devised, having an object to select an ARIMA forecasting model that can optimally execute stock management.

### SUMMARY

According to at least one of the embodiments of the present invention, a fluctuation value forecasting system having a fluctuation value forecasting unit configured to output a future forecasting value from time series data of fluctuation values by using an ARIMA model, includes a first forecasting unit configured to have the fluctuation value forecasting unit calculate first forecasting values, by using a plurality of ARIMA models, respectively, the ARIMA models being determined by using the time series data stored in a predetermined storage area; an index value calculation unit configured to calculate a first index value and a second index value, for each of the ARIMA models, by using the first forecasting values calculated by the first forecasting unit; a model selection unit configured to select one ARIMA model among the plurality of ARIMA models, based on the first index values and the second index values calculated by the index value calculation unit; and a second forecasting unit configured to have the fluctuation value forecasting unit calculate a second forecasting value as the future forecasting value of the time series data, by using the one ARIMA model selected by the model selection unit.

According to at least one of the embodiments of the present invention, it is possible to select an ARIMA forecasting model that can execute optimum stock management.

### BRIEF DESCRIPTION OF DRAWINGS

FIG. 1 is a hardware configuration of an example of a stock management system according to an embodiment of the present invention;

FIG. 2 is a functional block of an example of a stock management system according to the present embodiment;

FIG. 3 is a flowchart illustrating an example of a process flow for calculating ARIMA forecasting value data according to the present embodiment;

FIG. 4 is a diagram illustrating an example of a result of filtering;

FIG. 5 is a diagram illustrating an example of data patterns of models;

FIG. 6 is a flowchart illustrating an example of a process flow for selecting a forecasting model, and calculating safety stock according to the present embodiment;

FIG. 7 is a diagram illustrating an example of calculation of average stock by an accumulated error method;

FIGS. 8A-8B are diagrams illustrating an example of calculation of average stock by an error adjustment method;

FIG. 9 is a flowchart illustrating an example of a process flow for calculating an order quantity according to the present embodiment;

FIG. 10 is a diagram illustrating an example of calculation of order quantities by an accumulated error method;

FIGS. 11A-11B are diagrams illustrating an example of calculation of order quantities by an error adjustment method;

FIG. 12 is a diagram illustrating an example of a list of average stock of models, obtained by an accumulated error method and an error adjustment method;

FIG. 13 is a diagram illustrating an example of forecasting values and stock quantities for a selected forecasting model;

FIG. 14 is a diagram illustrating an example of a graph of actual values and forecasting values; and

FIG. 15 is a diagram illustrating an example of a graph of a stock quantity.

### DESCRIPTION OF EMBODIMENTS

In the following, embodiments of the present invention will be described in detail with reference to the drawings.

<Hardware Configuration>

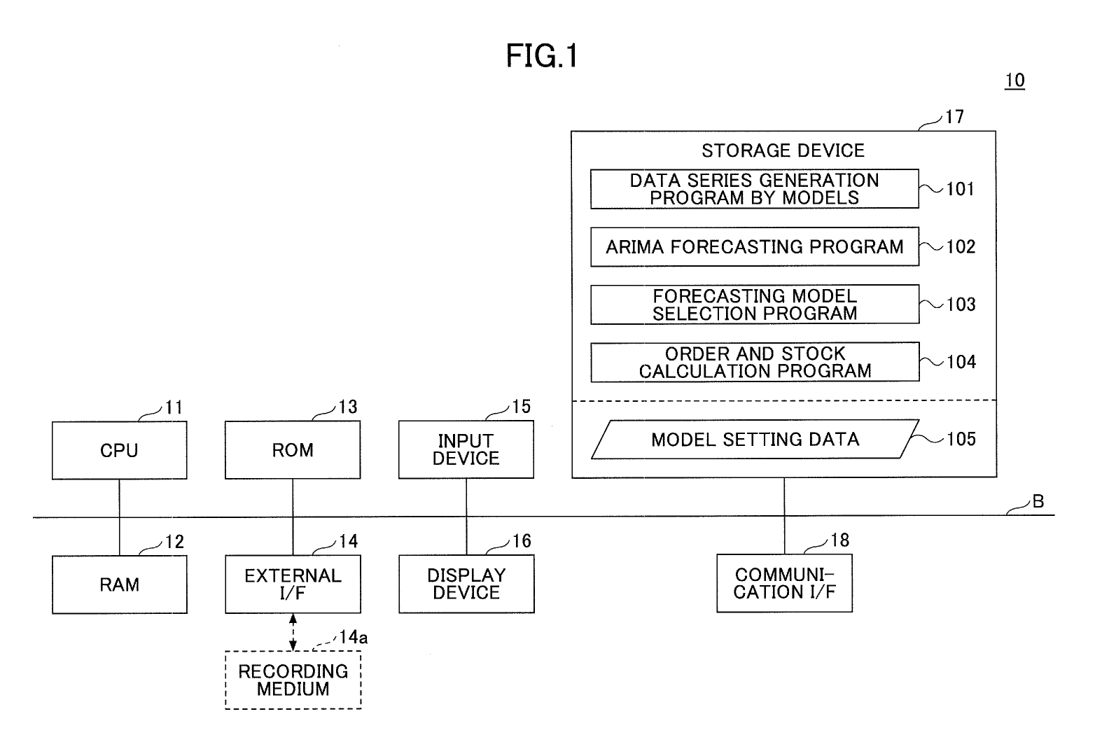

First, referring to FIG. 1, a hardware configuration of a stock management system 10 will be described according to the present embodiment. FIG. 1 is the hardware configuration of an example of a stock management system 10 according to the present embodiment. The stock management system 10 in the present embodiment includes a fluctuation value forecasting system as a part that forecasts change of a future fluctuation quantity based on time series data of the fluctuation quantity in the past. Therefore, the stock management system 10 in the present embodiment is a system that is suitable for forecasting future sales quantities of multiple goods at a supermarket, a department store, a convenience store or the like, by using a result of sales quantities in the past as time series data, and based on this forecasting result, estimating optimum quantities to be additionally bought (delivery quantities or production quantities) to manage the stock. Note that the stock management system 10 in the present embodiment includes a filtering unit to exclude data that needs a special statistical process, such as data on a bargain day at a supermarket.

As illustrated in FIG. 1, the stock management system 10 is implemented by a computer that includes a CPU (Central Processing Unit) 11, a RAM (Random Access Memory) 12, a ROM (Read-Only Memory) 13, an external I/F 14, an input device 15, a display device 16, a storage device 17, and a communication I/F 18 that are connected with each other by a bus B.

The CPU 11 is a processor that implements control and functions of the stock management system 10, by loading programs and data on the RAM 14 from the ROM 13 and the storage device 17, and executing a process.

The RAM 12 is a volatile semiconductor memory that temporarily stores programs and data. The ROM 13 is a non-volatile semiconductor memory that can store programs and data even when the power is turned off. The ROM 13 stores programs and data such as a BIOS (Basic Input/Output System) that is executed when activating the stock management system 10, OS (Operating System) settings, and network settings.

The external I/F 14 is an interface to an external apparatus. The external apparatus includes a recording medium 14a. The stock management system 10 can read and write data on the recording medium 14a via the external I/F 14.

The recording medium 14a is, for example, an SD memory card (SD Memory card). The recording medium 14a may be a USB memory (Universal Serial Bus memory), a DVD (Digital Versatile Disk), a CD (Compact Disk), a flexible disk, or the like.

The input device 15 includes a keyboard, a mouse, and the like that are used for inputting various operational signals into the stock management system 10. The input device 15 may be, for example, a touch panel. The display device 16 is an LCD (Liquid Crystal Display) or the like that displays a processed result by the stock management system 10. Note that the input device 15 and/or the display device 16 may be connected with the stock management system 10 by the communication I/F 18 via a network.

The communication I/F 18 is an interface to have the stock management system 10 connected with a network such as the Internet. This makes it possible for the stock management system 10 to execute data communications via the communication I/F 18.

The storage device 17 is, for example, a HDD (Hard Disk Drive), a SSD (Solid State Drive) or the like, and is a non-volatile memory to store programs and data. Programs and data stored in the storage device 17 include programs and data to implement the present embodiment, an OS, and application software running on the OS to provide various functions. The storage device 17 manages the stored programs and data by using a predetermined file system, DBs (databases), and the like.

The programs stored in the storage device to implement the present embodiment include a data series generation program by models 101, an ARIMA forecasting program 102, a forecasting model selection program 103, and an order and stock calculation program 104. Also, the data stored in the storage device 17 to implement the present embodiment includes model setting data 105. These programs and data may be stored in the recording medium 14a to be installed in the storage device 17, or may be downloaded from a server via the Internet and the like. These programs and data will be described in detail later.

The stock management system 10 in the present embodiment can implement various processes, which will be described later, on the hardware configuration described above. Note that the stock management system 10 in the present embodiment, and a fluctuation value forecasting system included in the stock management system 10 may be implemented on separate computers.

<Functional Configuration>

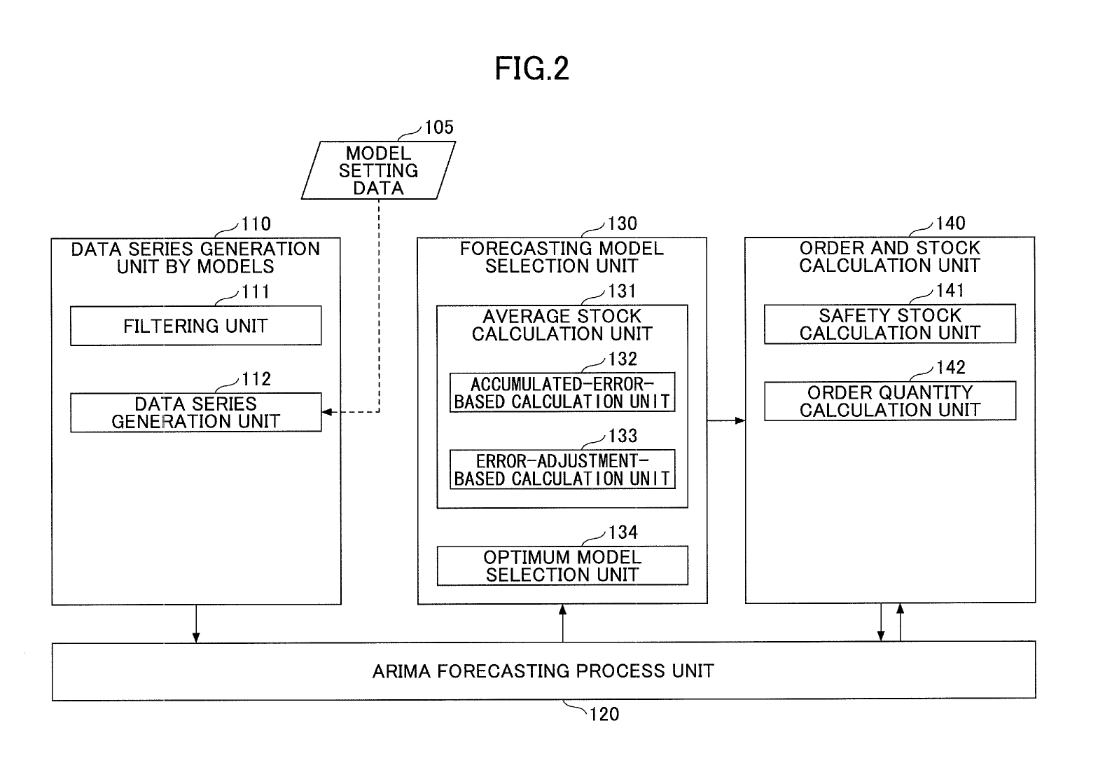

Next, a functional configuration of the stock management system 10 in the present embodiment will be described. FIG. 2 is a functional block of an example of the stock management system 10 according to the present embodiment. Functional blocks in FIG. 2 are implemented by the CPU 11 that executes respective programs stored in the storage device 17. As illustrated in FIG. 2, the stock management system 10 includes a data series generation unit by models 110 that functions when the data series generation program by models 101 is executed; an ARIMA forecasting process unit 120 that functions when the ARIMA forecasting program 102 is executed; a forecasting model selection unit 130 that functions when the forecasting model selection program 103 is executed; and an order and stock calculation unit 140 that functions when the order and stock calculation program 104 is executed. Note that the fluctuation value forecasting system included in the stock management system 10 is configured to include, for example, the data series generation unit by models 110, the ARIMA forecasting process unit 120, and the forecasting model selection unit 130.

Also, the data series generation unit by models 110 includes a filtering unit 111 and a data series generation unit 112. The forecasting model selection unit 130 includes an average stock calculation unit 131, an optimum model selection unit 134, and the average stock calculation unit 131 further includes an accumulated-error-based calculation unit 132 and an error-adjustment-based calculation unit 133. The order and stock calculation unit 140 includes a safety stock calculation unit 141 and an order quantity calculation unit 142.

The filtering unit 111 applies predetermined filtering to time series data (for example, daily data of actual results of sales quantities or the like) that is received as input. Note that the time series data is not limited to daily data, but may be input in a format of weekly data, monthly data, yearly data, or the like. Also, the time series data may be input via the recording medium 14a, the Internet or the like, or by using the input device 15.

Note that the predetermined filtering is a process to exclude specific data included in the time series data. For example, in a store such as a food supermarket, irregular bargain sales may be held, and it is practically difficult to forecast demand on such a bargain day. Therefore, a circumstance may arise where a stock quantity and a sales quantity are considerably deviated from each other on a bargain day. Also, on a usual sales day other than bargain days, excessive stock or underestimated stock may be generated as a backlash of bargain sales. Excessive stock results in increased stock of goods, and underestimated stock results in shortage of the goods.

In view of the above, it is necessary to exclude data of goods on a day estimated as a bargain day (specific data). The predetermined filtering to exclude such specific data may use a method, for example, that described in Japanese Patent No. 4981976.

The data series generation unit 112 generates data series by models from the time series data having the filtering applied by the filtering unit 111, based on parameters by the models defined in the model setting data 105. Note that a model is a data pattern of data series that is generated from the time series data having the filtering applied. For example, for the time series data having the filtering applied, the following models may be considered to process the data:

a logarithm model that generates data series by calculating logarithms (log model)

a square root model that generates data series by calculating square roots (√ model)

a previous-day difference model that generates data series by calculating previous-day differences (D1 model)

a previous-day difference plus previous-day difference model that generates data series by calculating previous-day differences of previous-day differences (D1D1 model)

a two-day moving average model that generates data series by calculating two-day moving averages (2DMA model)

a seven-day moving average model that generates data series by calculating seven-day moving averages (7DMA model)

a 21-day moving average model that generates data series by calculating 21-day moving averages (21DMA model).

As described above, data patterns can be generally classified into the difference series (D1 model and D1D1 model), the moving average series (2DMA model, 7DMA model, and 21DMA model), and the other series (log model and √ model). Note that square roots may be further calculated for data series having previous-day differences calculated, to consider a previous-day difference plus square root model (√D1 model). Namely, various models (data patterns) may be considered, by obtaining data series by applying predetermined data processes to the input time series data, such as a model that generates data series by combining the difference series, the moving average series, and the other series.

Note that if the input time series data is weekly data, monthly data, or yearly data, a previous-day difference may be replaced with a previous-week difference, a previous-month difference, or a previous-year difference, respectively, for example. Similarly, a two-day moving average and a seven-day moving average may be replaced with a two-week moving average and a seven-week moving average, two-month moving average and seven-month moving average, or a two-year moving average and a seven-year moving average, respectively.

As above, the data series generation unit 112 generates multiple data series of data patterns (namely, data series by multiple models) for the time series data having the filtering applied. In the present embodiment, difference series and moving average series are especially generated. Thus, for example, when calculating a forecasting value by using difference series by the ARIMA forecasting process unit 120, even if the forecasting fails (in other words, short-term waves constitute white noise), a medium or long term trend can be calculated as a forecasting value. This means that the fluctuation value forecasting system included in the stock management system 10 in the present embodiment makes a medium or long term forecasting, not a short-term forecasting if the short-term waves constitute white noise.

Also, if the time series data having the filtering applied includes deficiency or an abnormal value, the data series generation unit 112 may complement the deficient data, exclude the abnormal value, or replace the data. For example, if data on a specific day lacks in daily time series data, the specific day may be excluded, or complemented with a specific value (for example, the average value of the time series data). Also, for example, when generating data series of the logarithm model, if the time series data having the filtering applied includes “0” (abnormal value), the abnormal value may be excluded, or replaced with a specific value (for example, the average value of the time series data).

The ARIMA forecasting process unit 120 calculates forecasting values from respective data series generated by the data series generation unit 112. Also, using a model (data pattern) selected by the optimum model selection unit 134, the ARIMA forecasting process unit 120 calculates a future forecasting value from the input time series data.

The average stock calculation unit 131 includes an accumulated-error-based calculation unit 132 and an error-adjustment-based calculation unit 133. The accumulated-error-based calculation unit 132 calculates average stock for a certain period by an accumulated error method, based on the input time series data, and forecasting values calculated by the ARIMA forecasting process unit 120. Similarly, the error-adjustment-based calculation unit 133 calculates average stock for a certain period by an error adjustment method, based on the input time series data and forecasting values calculated by the ARIMA forecasting process unit 120. The average stock calculated by the accumulated error method, and the average stock calculated by the error adjustment method are examples of a first index value and a second index value, respectively.

Based on the average stock calculated by the accumulated error method and the average stock calculated by the error adjustment method, the optimum model selection unit 134 selects an optimum model to be used for calculating a future forecasting value. Namely, the optimum model selection unit 134 compares the average stock by the accumulated error method, with the average stock by the error adjustment method, for each of the data series of the multiple models (data patterns) generated by the data series generation unit 112, and selects a model having the lowest (least) average stock as the optimum model.

<Details of Processes>

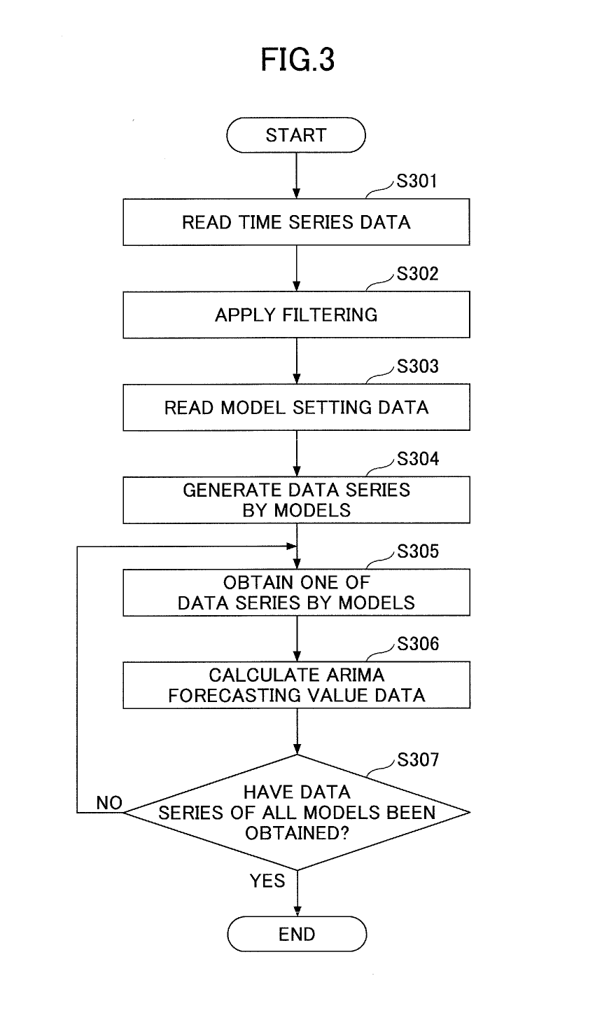

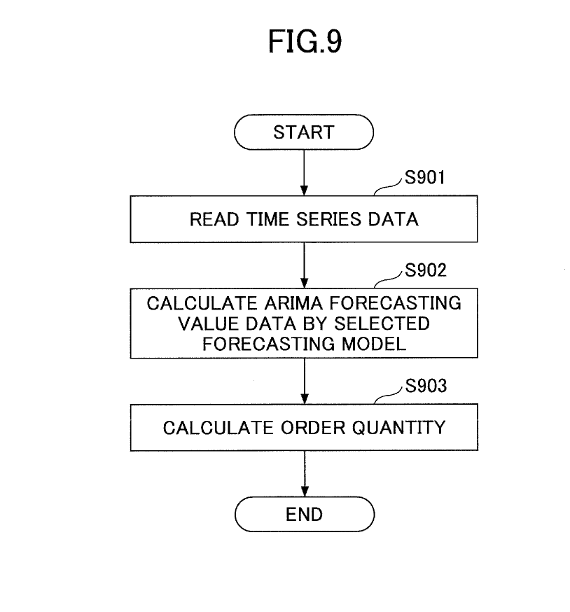

Next, details of processes of the stock management system 10 in the present embodiment will be described. Processes of the stock management system 10 can be generally classified into a simulation phase to select an optimum model for calculating a future forecasting value based on time series data in the past; and an operational phase to calculate the future forecasting value using the model selected in the simulation phase, and to calculate an optimum order quantity (delivery quantity or production quantity). Processes described using FIGS. 3-8 below are those in the simulation phase, whereas processes described using FIGS. 9-11 below are those in the operational phase.

<<Process to Calculate ARIMA Forecasting Value Data>>

First, a process will be described that calculates forecasting values of multiple models (ARIMA forecasting value data), based on input time series data. FIG. 3 is a flowchart illustrating an example of a process flow for calculating ARIMA forecasting value data according to the present embodiment.

At Step S301, the data series generation unit by models 110 inputs time series data. Note that the input time series data is, for example, daily data that represents actual results of sales quantities in the past. Such time series data is input, for example, via the recording medium 14a, the Internet, or the input device 15, as described above.

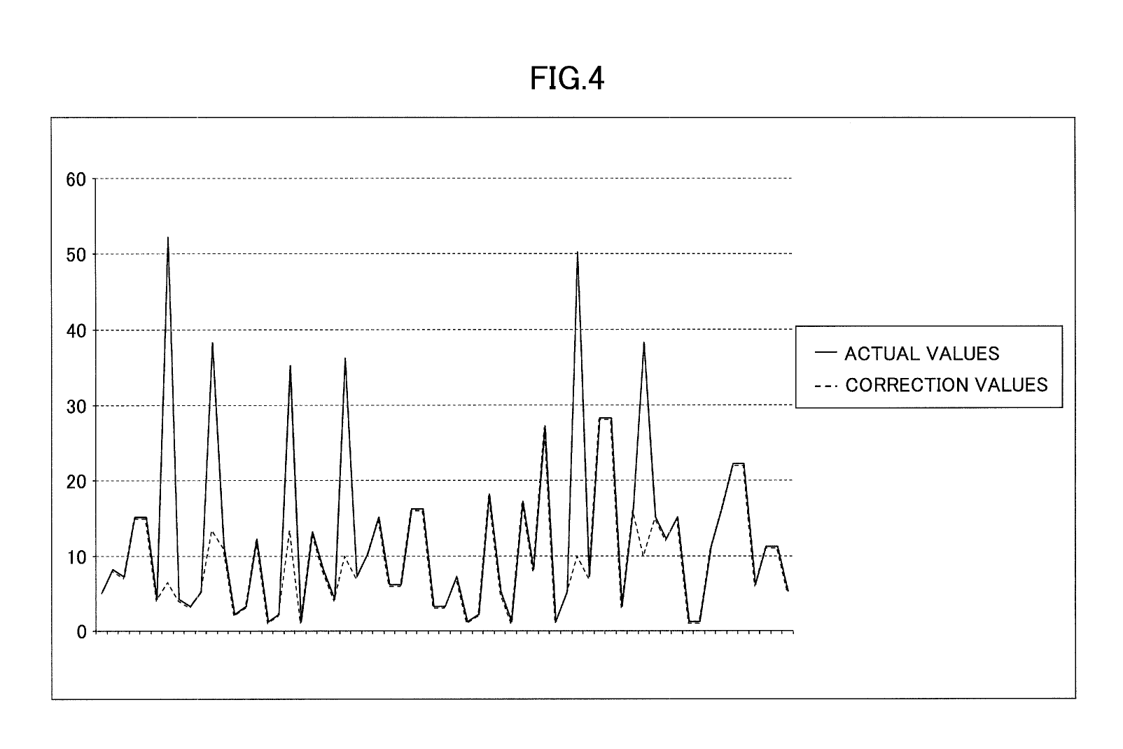

At Step S302, the filtering unit 111 applies the predetermined filtering to the input time series data. As described above, the filtering unit 111 executes a process, for example, to exclude data of actual results of sales quantities on bargain days. Namely, for example, as illustrated in FIG. 4, specific data of actual values designated by a solid line is corrected by correction values designated by a dashed line.

At Step S303, the data series generation unit by models 110 reads the model setting data 105. In the model setting data 105, parameters to represent a model (data pattern) are defined, and following these parameters, data processing is executed for the time series data having the filtering applied. Note that it is not necessary to use all defined models in the model setting data 105, and desired models may be selected, for example, by a user or a predetermined program. A model selected here may be an arbitrary model, but considering a case of failed forecasting as described above, it is preferable to select a moving average model in addition to a difference series model.

At Step S304, based on the model setting data 105 read at Step S303, the data series generation unit 112 generates multiple data series by models from the time series data having the filtering applied.

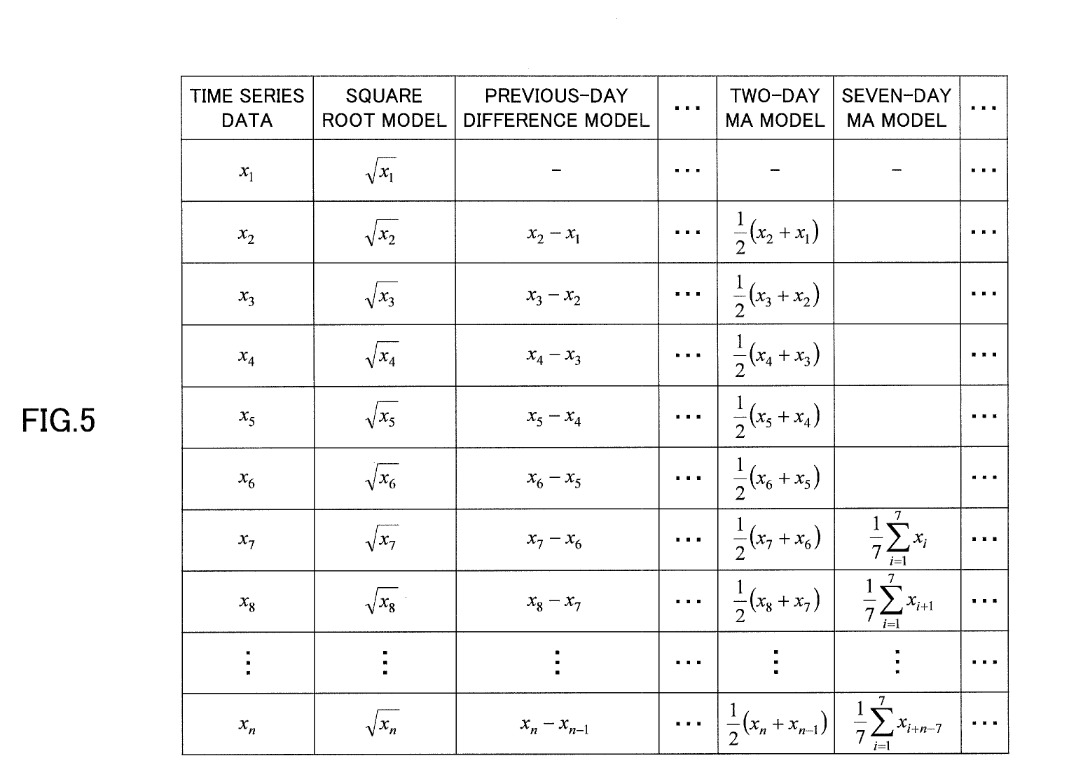

An example of data series by models that are generated by the data series generation unit 112 will be specifically described here, using FIG. 5. From time series data having the filtering applied, or {x₁, x₂, . . . , xₙ} data series by models are generated as follows.

As the square root model (√model), data series {√x₁, √x₂, . . . , √xₙ} are generated by calculating square roots for xᵢ (i=1 to n) in the time series data.

As the previous-day difference model (D1 model), data series {y₁, y₂, . . . , yₙ₋₁} are generated by calculating previous-day differences yᵢ₋₁=xᵢ−xᵢ₋₁ (i=2 to n) for xᵢ (i=1 to n) in the time series data.

As the two-day moving average model (2DMA model), data series {y₁, y₂, . . . , yₙ₋₁} are generated by calculating two-day (simple) moving averages yᵢ₋₁=(xᵢ+xᵢ₋₁)/2 (i=2 to n) for xᵢ (i=1 to n) in the time series data.

As seven-day moving average model (2DMA model) data series {y₁, y₂, . . . , yₙ₋₆} are generated by calculating seven-day (simple) moving averages yᵢ₋₆=(xᵢ+xᵢ₋₁+xᵢ₋₂+xᵢ₋₃+xᵢ₋₄+xᵢ₋₅+xᵢ₋₆)/7 (i=7 to n) for xᵢ (i=1 to n) in the time series data.

As above, based on the model setting data 105, the data series generation unit 112 generates data series of multiple models (data patterns) from the time series data having the filtering applied.

At Step S305, the ARIMA forecasting process unit 120 obtains one of the data series by models generated by the data series generation unit 112.

At Step S306, based on the obtained data series, the ARIMA forecasting process unit 120 calculates forecasting values (ARIMA forecasting value data). Note that calculation of the ARIMA forecasting value data may use a method, for example, that is described in Japanese Patent No. 4981976. Namely, for the obtained data series, the ARIMA forecasting process unit 120 calculates the ARIMA forecasting value data by the following steps.

(1) Define multiple degree patterns (for example, 50 patterns) of the model of the obtained data series.
(2) Estimate ARIMA parameters for each of the degree patterns.
(3) Calculate AICC and an error index for each of the degrees having the parameters determined.
(4) Select an optimum degree pattern based on the AICCs and error indices.
(5) Based on the ARIMA parameters of the selected degree pattern, using a predetermined formula, calculate forecasting value series and residual series to calculate the forecasting values (ARIMA forecasting value data).

Note that ARIMA forecasting value data is repeatedly calculated multiple times by units of predetermined periods. For example, if time series data having the filtering applied is {x₁, x₂, . . . , x₁₀₀}, by using a part of the time series data (the time series data for a predetermined period), or {x₁, x₂, . . . , x₃₀}, a first ARIMA forecasting value data {y₁, y₂, . . . y₇} is calculated. Next, by using the time series data {x₈, x₉, . . . , x₃₇}, a second ARIMA forecasting value data {y₈, y₉, . . . y₁₄} is calculated. Similarly, by using the time series data {x₁₅, x₁₆, . . . , x₄₂} a third ARIMA forecasting value data {y₁₅, y₁₆, . . . y₂₁} is calculated. Similarly repeating for a fourth ARIMA forecasting value data and after, the ARIMA forecasting value data {y₁, y₂, . . . y₇₇} are calculated. In the following, for example, for the ARIMA forecasting value data {y₁, y₂, . . . y₇₇}, the time series data having the filtering applied {x₈, x₉, . . . , x₈₄} at the same timings (namely, the same days, the same months, and the same years) is represented as {x₁, x₂, . . . , x₇₇}, to designate a timing by a subscript in data series.

At Step S307, the forecasting model selection unit 130 determines whether data series of all models generated at Step S305 have been obtained. If data series of all models have not been obtained, the process goes back to Step S305; or if data series of all models have been obtained, the process ends. Namely, the ARIMA forecasting process unit 120 calculates the ARIMA forecasting value data for the data series of all models generated by the data series generation unit by models 110.

Thus, data series of multiple models are generated from the time series data that represents actual results of sales quantities in the past or the like. Then, the ARIMA forecasting value data is calculated for each of the generated data series.

<<Process to Select Forecasting Model and to Calculate Safety Stock>>

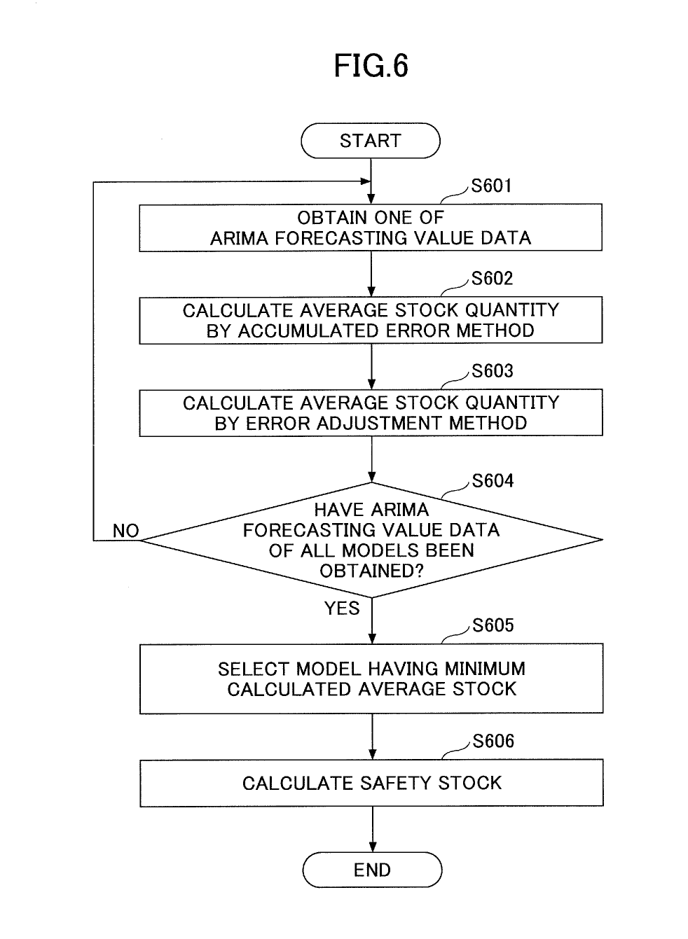

Next, a process will be described that selects an optimum model among multiple models based on the ARIMA forecasting value data by the models calculated by the process described using FIG. 3, and calculates safety stock by using the selected model. FIG. 6 is a flowchart illustrating an example of a process flow for selecting a forecasting model, and calculating safety stock according to the present embodiment. The safety stock here is, as will be described later, the sum (or difference) of theoretical safety stock calculated from an allowable ratio of stockout (shortage of goods), and a margin arbitrarily set by a user.

At Step S601, the average stock calculation unit 131 obtains one of the ARIMA forecasting value data among the ARIMA forecasting value data by multiple models calculated by the ARIMA forecasting process unit 120. Note that at this moment, if the obtained ARIMA forecasting value data is that which has been calculated by using a difference series model, a summation is executed, for example, as described in Japanese Patent No. 4981976.

At Step S602, the accumulated-error-based calculation unit 132 calculates an average stock quantity by an accumulated error method, based on the time series data having the filtering applied, and the obtained ARIMA forecasting value data.

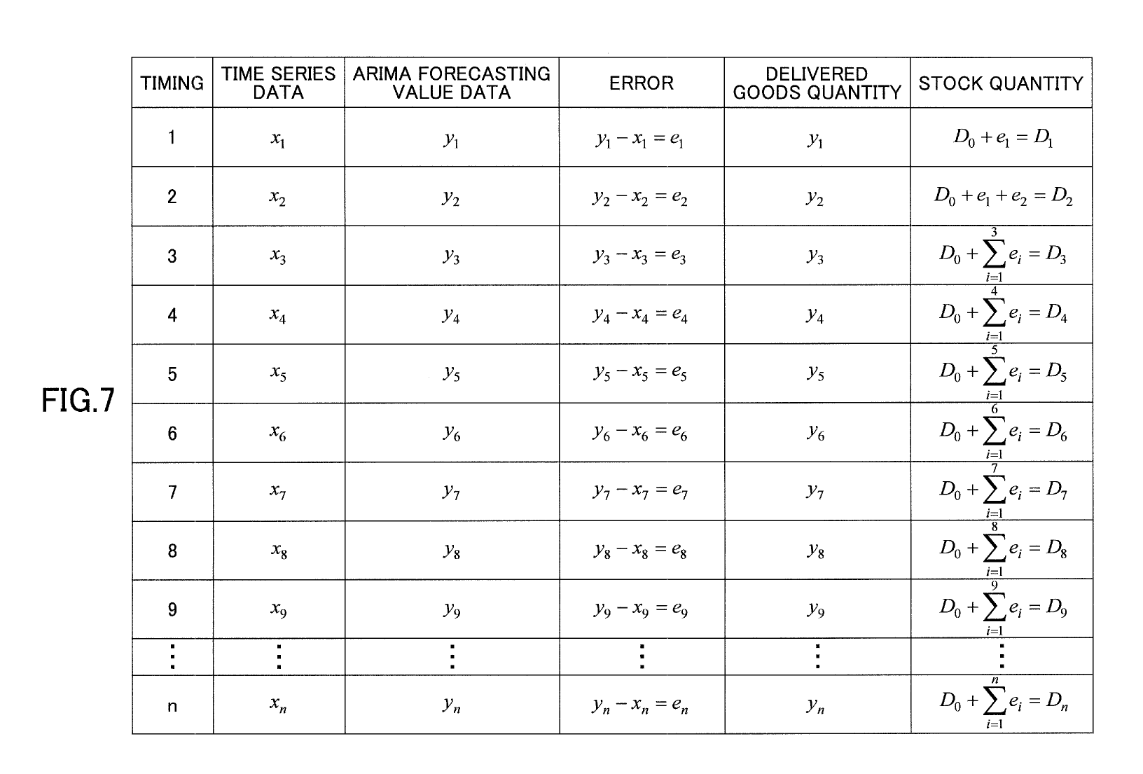

Here, calculation of an average stock quantity by the accumulated error method will be described using FIG. 7. FIG. 7 is a diagram illustrating calculation of average stock by the accumulated error method. The accumulated error method is a method for delivering, ordering and producing goods, as indicated by ARIMA forecasting value data. In FIG. 7, timings (1 to n) represent, for example, days for daily data, months for monthly data, and years for yearly data. Time series data is that having the filtering applied. ARIMA forecasting value data is forecasting values calculated by the ARIMA forecasting process unit 120. An error is a difference between ARIMA forecasting value data at a timing, and the time series data at the same timing corresponding to the ARIMA forecasting value data. A delivery quantity is an increased stock quantity at a timing, and also a delivered quantity (produced quantity) to be stocked.

Assuming that an initial stock quantity is D₀, the stock quantity D₁ at timing 1 is D₀+y₁−x₁=D₀+e₁. Similarly, the stock quantity D₂ at timing 2 is D₀+e₁+y₂−x₂=D₀+e₁+e₂. The same applies to the following; the stock quantity Dₖ at timing k (k=1 to n) is represented by the following formula (3) in general.

$${D}_{k} = {D}_{0} + {\sum }_{i = 1}^{k} {e}_{i} \qquad ( 3 )$$

Therefore, average stock AVE₁ (D) for timings 1 to n by the accumulated error method is represented by the following formula (4).

$${AVE}_{1} ( D ) = \frac{1}{n} {\sum }_{k = 1}^{n} {D}_{k} = {D}_{0} + \frac{1}{n} {\sum }_{k = 1}^{n} {\sum }_{i = 1}^{k} {e}_{i} \qquad ( 4 )$$

Note that, in practice, in general, it is often the case that shortage of goods (stockout) is not allowed. Therefore, Dₖ>0 needs to be satisfied at any timing k as a condition in practice. With this condition, the initial stock D₀ is represented by the following formula (5).

$${D}_{0} = \{ \begin{matrix}\vert {min}_{1 ≦ k ≦ n} {\sum }_{i = 1}^{k} {e}_{i} \vert & if {\sum }_{i = 1}^{k} {e}_{i} < 0 \\ 0 & if {\sum }_{i = 1}^{k} {e}_{i} ≧ 0\end{matrix} \qquad ( 5 )$$

Consequently, in practice, the average stock AVE₁ (D) by the accumulated error method is represented by the following formula (6).

$${AVE}_{1} ( D ) = \{ \begin{matrix}\vert {min}_{1 ≦ k ≦ n} {\sum }_{i = 1}^{k} {e}_{i} \vert + \frac{1}{n} {\sum }_{k = 1}^{n} {\sum }_{i = 1}^{k} {e}_{i} & if {\sum }_{i = 1}^{k} {e}_{i} < 0 \\ \frac{1}{n} {\sum }_{k = 1}^{n} {\sum }_{i = 1}^{k} {e}_{i} & if {\sum }_{i = 1}^{k} {e}_{i} ≧ 0\end{matrix} \qquad ( 6 )$$

At Step S603, the error-adjustment-based calculation unit 133 calculates the average stock quantity by the error adjustment method, based on the time series data having the filtering applied and the obtained ARIMA forecasting value data.

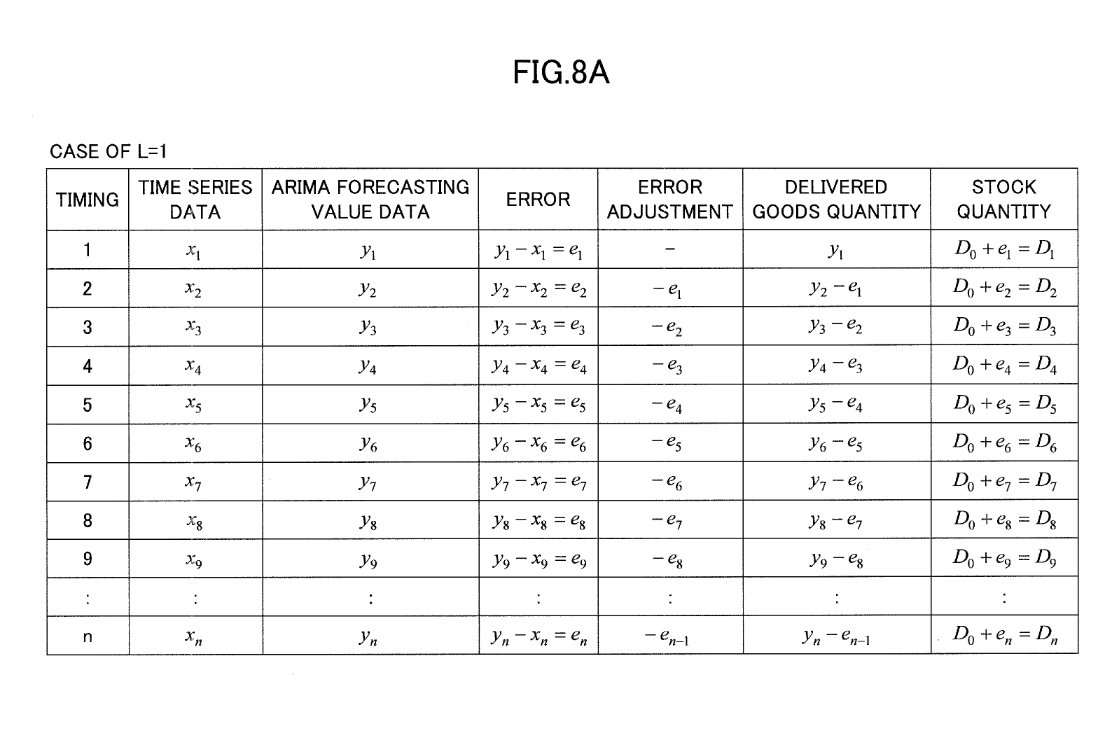

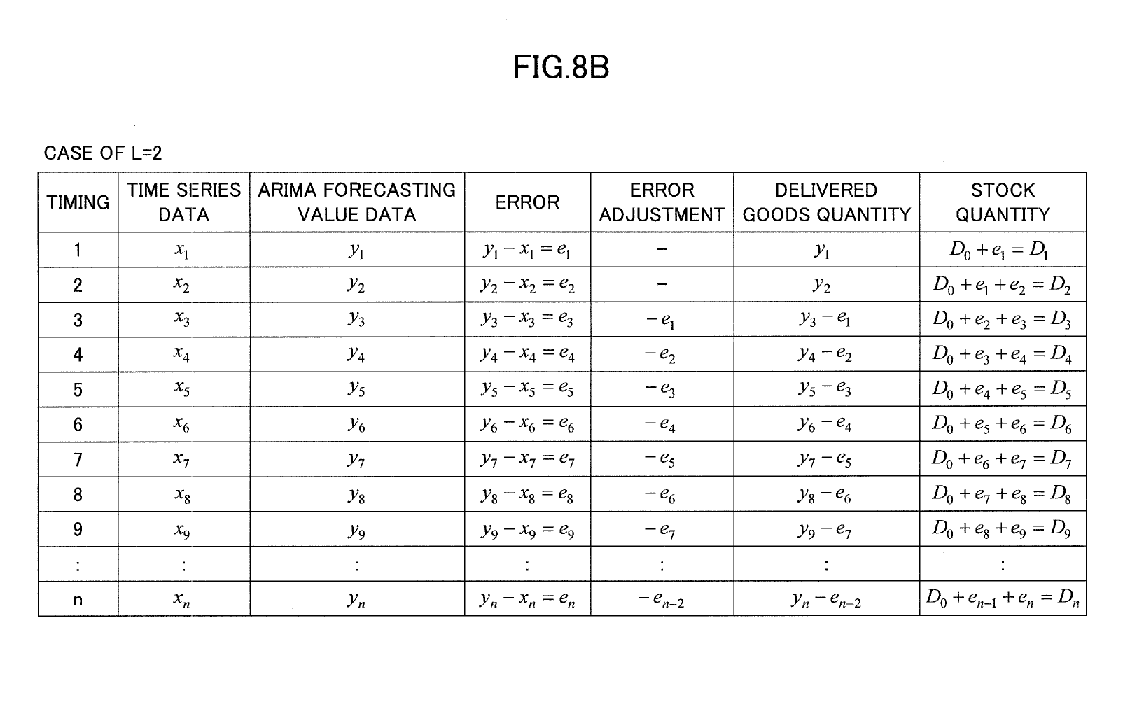

Here, calculation of an average stock quantity by the error adjustment method will be described using FIGS. 8A-8B. FIGS. 8A-8B are diagrams illustrating calculation of average stock by the error adjustment method. The error adjustment method is a method that adjusts errors between ARIMA forecasting value data and the time series data having the filtering applied by considering a lead time of goods and the like. Here, the lead time is a period that is required from order to delivery of goods and the like.

FIG. 8A is a diagram illustrating a case where the lead time is 1. In this case, a stock quantity D₁ at timing 1 is D₀+y₁−x₁=D₀+e₁. Here, since the lead time is 1, the error e₁ generated at timing 1 is adjusted by −e₁ at timing 2. Therefore, a stock quantity D₂ at timing 2 is D₀+y₂-x₂-e₁=D₀+e_{2.}

Similarly, the error e₂ generated at timing 2 is adjusted by −e₂ at timing 3. Therefore, D₃ at timing 3 is D₀+y₃-x₃-e₂=D₀+e₃. The same applies to the following; a stock quantity Dₖ at timing k is represented by the following formula (7).

Dₖ=D₀+eₙ (7)

Therefore, when the lead time is 1, the average stock AVE₂ (D_{L=1}) for timings 1 to n by the error adjustment method is represented by the following formula (8).

$${AVE}_{2} ( {D}_{L = 1} ) = {D}_{0} + \frac{1}{n} {\sum }_{i = 1}^{n} {e}_{i} \qquad ( 8 )$$

Also, FIG. 8B is a diagram illustrating a case where the lead time is 2. In this case, similarly to the case where the lead time is 1, the average stock AVE₂ (D_{L=2}) for timings 1 to n is calculated and represented by the following formula (9).

$${AVE}_{2} ( {D}_{L = 2} ) = {D}_{0} + \frac{2}{n} {\sum }_{i = 1}^{n} {e}_{i} - \frac{1}{n} {e}_{n} \qquad ( 9 )$$

Therefore, in general, when the lead time is m, the average stock AVE₂ (D_{L=m}) for timings 1 to n is represented by the following formula (10).

$$AVE ( {D}_{L = m} ) = {D}_{0} + \frac{m}{n} {\sum }_{i = 1}^{n} {e}_{i} - Δ \qquad ( 10 )$$

where Δ in formula (10) is represented by the following formula (11).

$$Δ = \frac{1}{n} \{ ( L - 1 ) {e}_{n} + ( L - 2 ) {e}_{n - 1} + … + {e}_{n - ( L - 2 )} \} \qquad ( 11 )$$

Also, similarly to what described for the accumulated error method, under the condition that stockout is not allowed at timings 1 to n, an initial stock D₀ by the error adjustment method is represented by the following formula (12) when the lead time is m.

$${D}_{0} = \{ \begin{matrix}min \{ \vert min {\sum }_{j = 0}^{k} {e}_{j + 1} \vert , \vert min {\sum }_{j = 1}^{m} {e}_{k + j} \vert \} & if {\sum }_{j = 0}^{k} {e}_{j + 1} < 0 and {\sum }_{j = 1}^{m} {e}_{k + j} < 0 \\ max \{ 0 , \vert min {\sum }_{j = 1}^{m} {e}_{k + j} \vert \} & if {\sum }_{j = 0}^{k} {e}_{j + 1} ≧ 0 and {\sum }_{j = 1}^{m} {e}_{k + j} < 0 \\ max \{ \vert min {\sum }_{j = 0}^{k} {e}_{j + 1} \vert , 0 \} & if {\sum }_{j = 0}^{k} {e}_{j + 1} < 0 and {\sum }_{j = 1}^{m} {e}_{k + j} ≧ 0 \\ 0 & if {\sum }_{j = 0}^{k} {e}_{j + 1} ≧ 0 and {\sum }_{j = 1}^{m} {e}_{k + j} ≧ 0\end{matrix} \qquad ( 12 )$$

However, in practice, when the lead time is m, assuming that the stock quantity Dₖ is greater than 0 at timings m and after (namely, stockout is not allowed at timings m and after), instead of formula (12), the following formula (13) is often used.

$${D}_{0} = \vert min {\sum }_{j = 0}^{m} {e}_{i + j} \vert \qquad ( 13 )$$

At Step S604, the forecasting model selection unit 130 determines whether the ARIMA forecasting value data has been obtained for all models. In other words, for all models of the ARIMA forecasting value data generated at Step S304 in FIG. 3, the forecasting model selection unit 130 determines whether the average stock is calculated by the accumulated error method and the error adjustment method. If the ARIMA forecasting value data has been obtained for all models, the process goes forward to Step S605; or if the ARIMA forecasting value data has not been obtained for all models, the process goes back to Step S601.

At Step S605, among the average stock calculated by the accumulated error method, and the average stock calculated by the error adjustment method, which have been calculated from the ARIMA forecasting value data of all models, the optimum model selection unit 134 selects a model having the minimum calculated average stock as a forecasting model to be used in the operational phase. Namely, the optimum model selection unit 134 calculates formula (4) and formula (10) for all models, and selects a model having the minimum average stock as an optimum forecasting model.

In this way, in the simulation phase, the stock management system 10 in the present embodiment selects an optimum model among multiple models based on time series data including actual results of sales quantities in the past and the like. Here, a criterion to select an optimum model is to select a model that has the smallest average stock for a period to be covered. This makes, even though the ARIMA forecasting value data may include a fault in forecasting precision to an extent considered as inferior, the forecasting error be sufficiently smaller than a maximum sales quantity in the past (in practice, ad is calculated as a maximum sales quantity in the past), and the following formula (14) is satisfied in general.

$$σ d \times m > \vert min {\sum }_{j = 0}^{m} {e}_{i + j} \vert \qquad ( 14 )$$

Therefore, by using the selected forecasting model in the operational phase to calculate an order, delivery, or production quantity, and executing the order, delivery, or production following the calculated value, the (average) stock quantity is considerably reduced, compared to a proper stock quantity in the conventional management engineering or the like.

At Step S606, the safety stock calculation unit 141 calculates the safety stock, by using the ARIMA forecasting value data of the forecasting model selected at Step S605. Here, the safety stock is the sum (or difference) of theoretical safety stock calculated from an allowable ratio of stockout (shortage of goods), and a margin arbitrarily set by a user. In the following, this safety stock is referred to as the “applied safety stock”.

Generally, the theoretical safety stock often assumes in practice that the allowable ratio of stockout is set to “0” (namely, stockout is not allowed). However, for example, for goods having short consumption time limits such as side dishes, lunch boxes, and the like, there are cases where the stockout ratios are set to values greater than zero to avoid discarding the goods due to having excessive stock. Note that a stockout ratio ρ is a ratio of stockout generated in a covered period (for example, counted by the number of days), and in general, represented by the following formula (15).

$$STOCKOUT RATIO ρ = \frac{STOCKOUT TIMES}{COVERED PERIOD} \qquad ( 15 )$$

Here, a case where the stockout ratio ρ=0 will be described as an example. For example, in FIG. 8A, to have the stockout ratio ρ=0, it is necessary to satisfy the stock quantity Dₖ>0 at each timing k. Namely, an initial stock quantity D₀ required for not generating stockout is represented by the following formula (16).

$${D}_{0} = \vert {min}_{1 ≦ k ≦ n} {e}_{k} \vert \qquad ( 16 )$$

The initial stock quantity D₀ represented by formula (16) is referred to as the theoretical safety stock. Note that although the case described here assumes that the lead time is 1 and use of the error adjustment method, the theoretical safety stock can be similarly calculated with a condition of the stock quantity Dₖ>0 at each timing, for a case using the accumulated error method, or for a case using the error adjustment method and the lead time greater than or equal to 2. Also, for a case where the stockout ratio ρ>0, by calculating the number of occurrences of the stockout by formula (15), the theoretical safety stock is calculated. For example, if the number of occurrences is one by formula (15) for a given stockout ratio ρ, the theoretical safety stock in FIG. 8A is the absolute value of eₖ having the second smallest value.

For the theoretical safety stock calculated as described above, the applied safety stock is obtained by adding or subtracting a predetermined margin. Here, the margin is a correction quantity for the theoretical safety stock, which is set by a user or the like. Cases of adding the margin include a case, for example, where even though there is a likelihood that excessive stock is generated, the user does not want to have stockout generated. On the other hand, cases of subtracting the margin include a case, for example, where even though there is a likelihood that stockout is generated, the user does not want to have excessive stock generated. A margin is obtained, for example, by multiplying the average stock in a covered period, by an arbitrary value determined by a user or the like (for example, 0≦value≦1). In the following, the applied safety stock is represented by D_{s.}

<<Process to Calculate Order Quantity>>

Next, a process in the operational phase will be described that calculates a future forecasting value by using an optimum forecasting model selected in the simulation phase, and calculates an optimum order quantity (delivery quantity or production quantity). Note that the optimum order quantity (delivery quantity or production quantity) is defined as a minimum stock quantity with which stockout is not generated. Namely, the stock management system 10 in the present embodiment can maintain a minimum stock quantity with which stockout is not generated, by calculating an optimum order quantity (delivery quantity or production quantity), based on a forecasting model selected in the simulation phase, and the calculated applied safety stock. In addition, as represented by formula (14), this minimum stock quantity with which stockout is not generated is considerably smaller than a proper stock quantity in the conventional management engineering or the like. Therefore, the stock management system 10 in the present embodiment can considerably reduce the stock quantity. Note that it is preferable to execute a simulation phase, for example, every several months to update the forecasting model.

FIG. 9 is a flowchart illustrating an example of a process flow for calculating an order quantity according to the present embodiment. At Step S901, the data series generation unit by models 110 inputs the time series data. Similarly to Step S301 in FIG. 3, the time series data input here is, for example, daily data that represents actual results of sales quantities in the past. This time series data is input, for example, via the recording medium 14a, the Internet, or the input device 15, as described above.

Then, the data series generation unit 112 generates data series of a data pattern corresponding to a forecasting model selected in the simulation phase, from the input time series data. For example, if the forecasting model is the 7DMA model (seven-day moving average model), the data series generation unit 112 generates data series by calculating seven-day moving averages on the input time series data.

At Step S902, the ARIMA forecasting process unit 120 calculates the ARIMA forecasting value data by using the data series generated at Step S901 (namely, data series of the forecasting model).

At Step S903, the order quantity calculation unit 142 calculates an order quantity, based on the ARIMA forecasting value data calculated at Step S901 and the applied safety stock Dₛ calculated in the simulation phase.

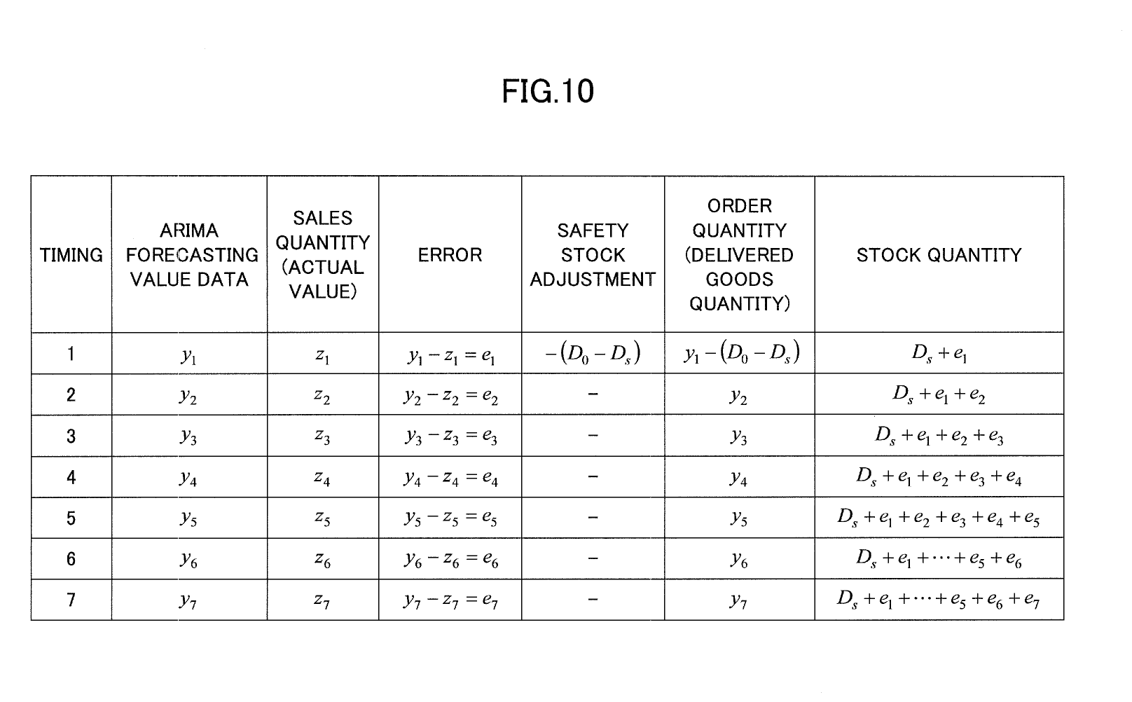

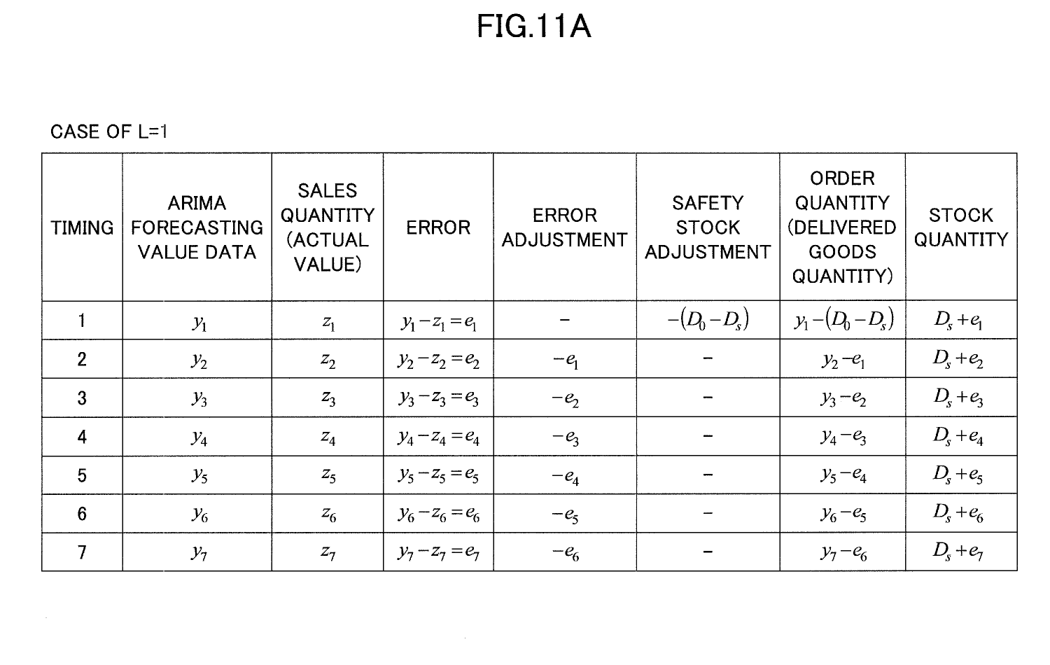

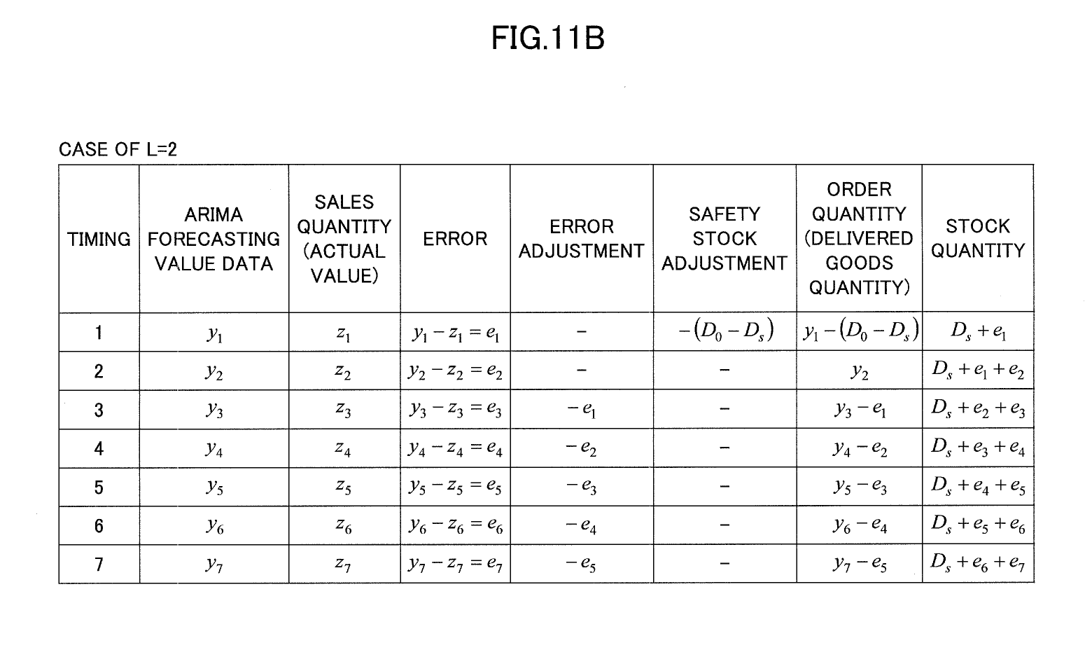

Calculation of an order quantity by the order quantity calculation unit 142 will be described more specifically, using FIG. 10 and FIGS. 11A-11B. An order quantity is calculated by using one of the accumulated error method and the error adjustment method that gives a smaller value of the average stock for a forecasting model selected in the simulation phase. Namely, if (the average stock of the selected forecasting model by the accumulated error method)<(the average stock of the selected forecasting model by the error adjustment method), then, the order quantity is calculated by the accumulated error method. On the other hand, if (the average stock of the selected forecasting model by the accumulated error method)>(the average stock of the selected forecasting model by the error adjustment method), then, the order quantity is calculated by the error adjustment method.

First, a case will be described where the order quantity is calculated by the accumulated error method. FIG. 10 is a diagram illustrating calculation of order quantities by the accumulated error method. ARIMA forecasting value data {y₁, y₂, . . . , y₇} is forecasting values calculated at Step S902. A sales quantity (actual value) is a sales quantity of goods or the like at a timing. An error is an error between the ARIMA forecasting value data and an actual value. Safety stock adjustment is an adjustment quantity of the applied safety stock Dₛ with respect to an initial stock D₀. The safety stock adjustment is used for adjusting the order quantity at timing 1.

Using these, the order quantity at timing 1 is calculated as y₁-(D₀-Dₛ). Thus, the stock quantity at timing 1 is Dₛ+e₁. Next, at timing 2 or after, the forecasting value by the ARIMA forecasting value data is taken as the order quantity, for example, the order quantity at timing k is yₖ, and the stock quantity at timing k is Dₛ+e₁+ . . . +eₖ. Therefore, in general, the average stock for timings 1 to n is represented by the following formula (17).

$$AVE ( D ) = {D}_{s} + \frac{1}{n} {\sum }_{k = 1}^{n} {\sum }_{i = 1}^{k} {e}_{i} \qquad ( 17 )$$

This implies that an order (delivery or production) may be executed to have the average stock quantity for a covered period be the applied safety stock Dₛ. Moreover, as represented by formula (14), the applied safety stock D₅ is considerably smaller than a proper stock quantity in the conventional management engineering or the like. Therefore, by making an order with an optimum order quantity (delivery quantity or production quantity) calculated to have the average stock quantity for a covered period be the applied safety stock Dₛ, goods can be managed with the stock quantity considerably smaller than conventional one, without generating stockout.

Next, a case will be described where the order quantity is calculated by the error adjustment method. FIGS. 11A-11B are diagrams illustrating calculation of order quantities by the error adjustment method. FIG. 11A is a diagram illustrating a case where the lead time is 1. In this case, similarly to calculation of an order quantity by the accumulated error method, by using the safety stock adjustment, the order quantity at timing 1 is calculated as y₁-(D₀-Dₛ). Thus, the stock quantity at timing 1 is Dₛ+e₁. Next, at timing 2 or after, the order quantity is adjusted with an error with respect to the forecasting value by the ARIMA forecasting value data depending on a timing with respect to the lead time; for example, the order quantity is yₖ-eₖ₋₁ at timing k, and the stock quantity at timing k is Dₛ+e_{k.}

For a case where the lead time is 2, the order quantity is calculated similarly. The order quantity at timing k is y₁-(D₀-Dₛ) for k=1; y₂ for k=2; or yₖ-eₖ₋₂ for k=3 or greater. Also, the stock quantity at timing k is Dₛ+e₁+ . . . +e_{k.}

Thus, in general, when the lead time is m, the average stock for timings 1 to n is represented by the following formula (18) where A in formula (18) is the same as in formula (11).

$$AVE ( D ) = {D}_{s} + \frac{m}{n} {\sum }_{i = 1}^{n} {e}_{i} - Δ \qquad ( 18 )$$

This implies, similarly to what described for the accumulated error method, that an order (delivery or production) may be executed to have the average stock quantity for a covered period be the applied safety stock Dₛ. Also, as represented by formula (18), the applied safety stock Dₛ, is considerably smaller than a proper stock quantity in the conventional management engineering or the like. Therefore, by making an order with an optimum order quantity (delivery quantity or production quantity) calculated to have the average stock quantity for a covered period be the applied safety stock Dₛ, goods can be managed with stock quantity considerably smaller than conventional one, without generating stockout.

### SUMMARY

As described above, the stock management system 10 in the present embodiment generates data series of multiple models (data patterns) including moving average series for making medium or long term forecasting, based on the time series data of actual results of sales quantities in the past or the like, and calculates the ARIMA forecasting value data for the respective generated data series. Then, for the calculated ARIMA forecasting value data, the stock management system 10 calculates the average stock for a covered period by two methods of the accumulated error method and the error adjustment method, and adopts a model having the smallest average stock as a forecasting model. Also, using the adopted forecasting model, the safety stock is calculated to allow a desired stockout ratio.

The stock management system 10 in the present embodiment calculates an optimum order quantity (delivery quantity or production quantity) based on the forecasting model and the safety stock. Namely, the stock management system 10 in the present embodiment calculates an order quantity with which goods can be managed to have the stock quantity that is considerably smaller than a proper stock quantity in the conventional management engineering or the like. Thus, a user of the stock management system 10 in the present embodiment can manage goods with a management cost considerably lower than a conventional cost, without losing sales opportunities due to excessive stock and stockout.

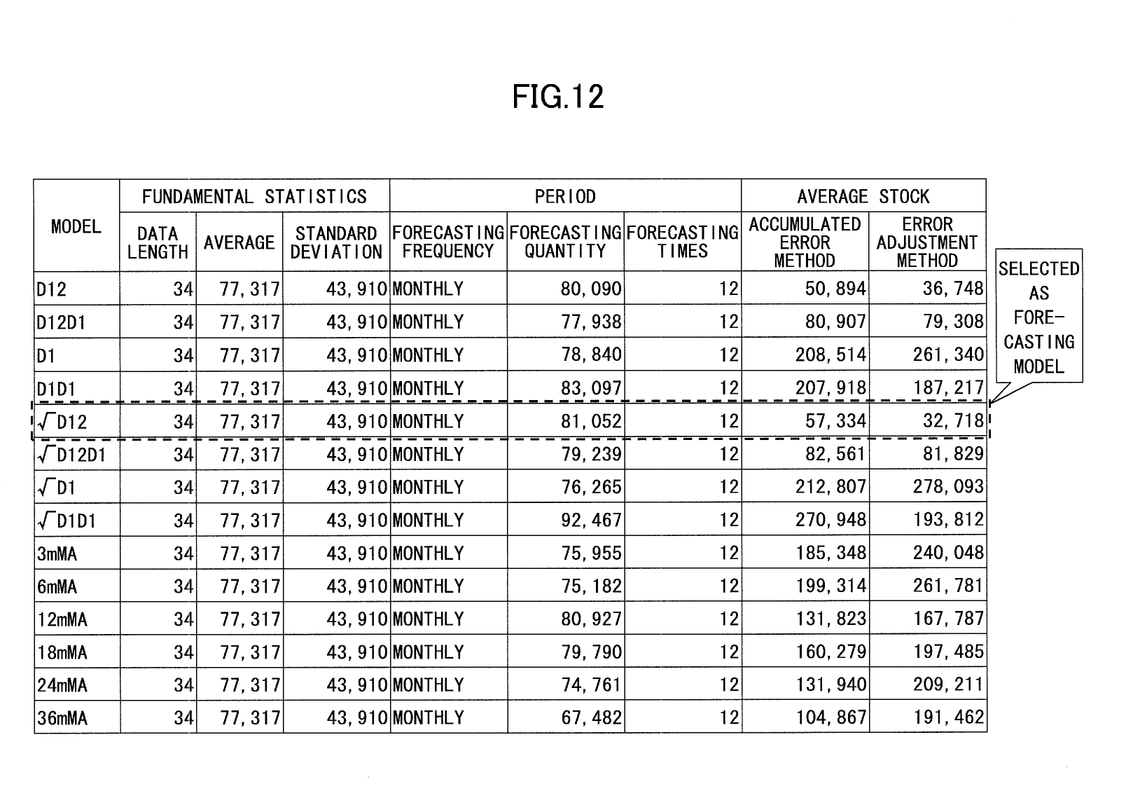

For example, assume that average stocks are obtained as illustrated in FIG. 12 by the accumulated error method and the error adjustment method in the simulation phase, for models (data patterns) of the time series data representing monthly actual results of sales quantities in the past. Note that in the column of “model” in FIG. 12, for example, D12 model is a model that generates data series by calculating differences with year-ago months, and 12 mMA model is a model that generates data series by calculating 12-month moving averages. For respective models of D12 model to 36 mMA model, the average stock is calculated by the accumulated error method and the error adjustment method. Then, among the average stock of all models by the accumulated error method and the error adjustment method, √D12 model is selected as a forecasting model because its average stock by the error adjustment method is the smallest among all models.

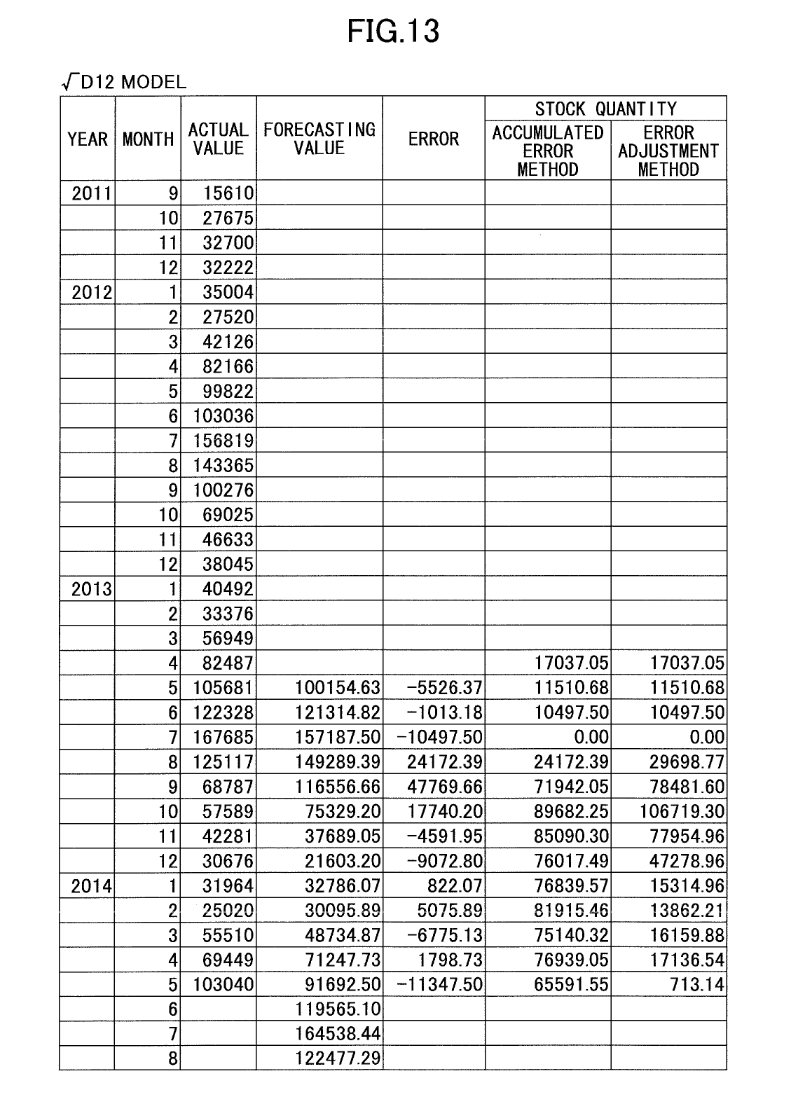

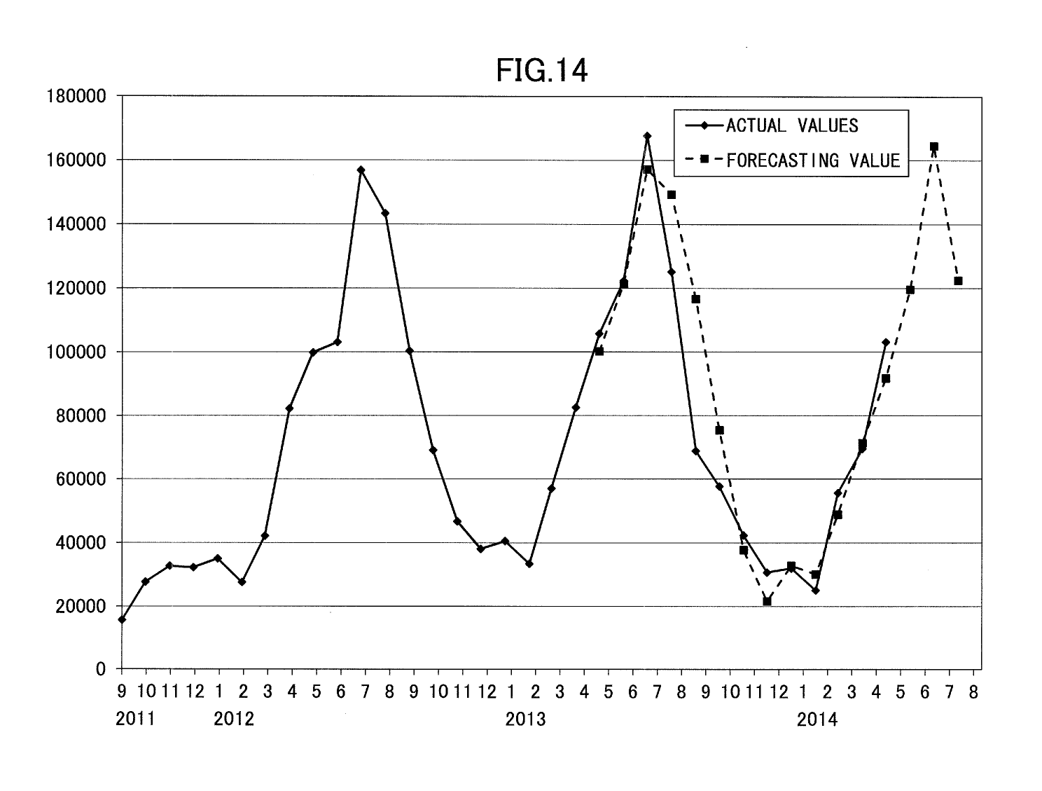

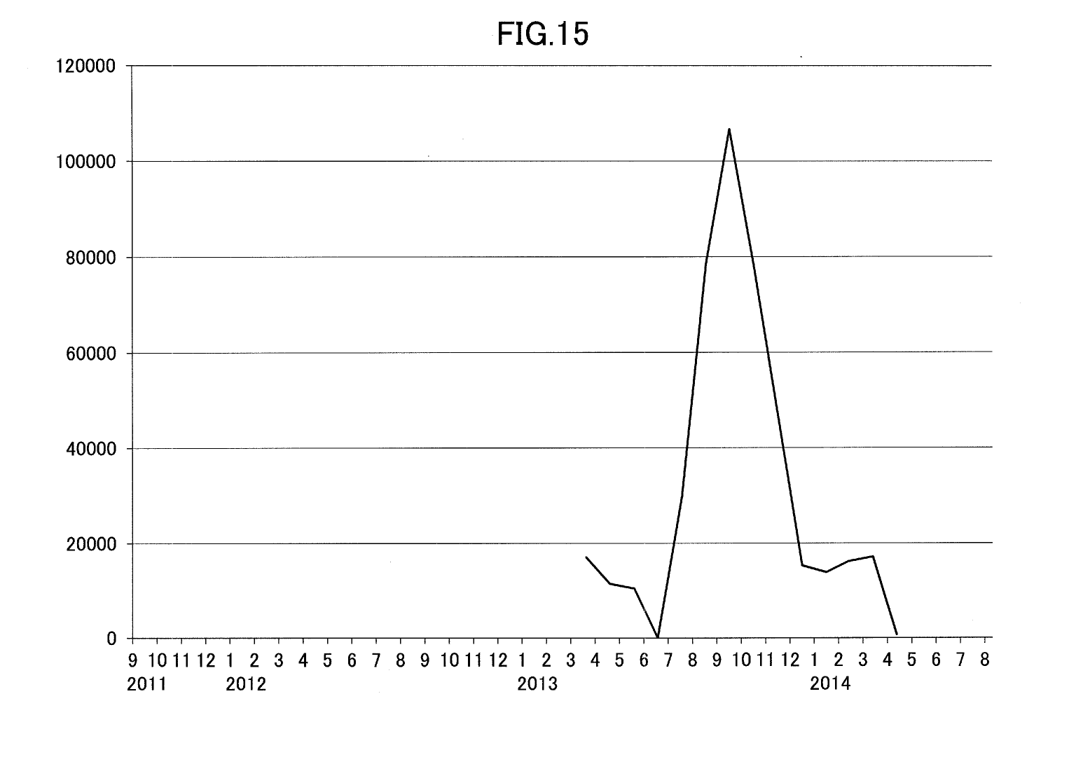

Next, assume that for the selected forecasting model of √D12, the ARIMA forecasting value data (forecasting values) are calculated in the operational phase, as illustrated in FIG. 13. These actual values and the ARIMA forecasting value data may be represented as a graph illustrated in FIG. 14. FIG. 13 is for a case where the lead time is 3, and illustrates calculated results of ARIMA forecasting value data from May 2013 to August 2013, based on the time series data representing monthly actual results of sales quantities from September 2011 to February 2013. This shows that the average stock calculated by the accumulated error method from May 2013 to May 2014 is about 32,717. Therefore, this average stock quantity indicates the proper stock. The stock quantity by the accumulated error method in FIG. 13 is represented, for example, as a graph illustrated in FIG. 15.

On the other hand, a proper stock by the conventional management engineering or the like (namely, the maximum actual results of sales quantities in the past multiplied by the lead time), is estimated to about 503,055. Therefore, the proper stock is reduced to about one tenth of that obtained conventionally.

Note that the ARIMA forecasting process unit 120 in the present embodiment is an example of a first forecasting unit and a second forecasting unit. The average stock calculation unit 131 is an example of an index value calculation unit. The optimum model selection unit 134 is an example of a model selection unit. The data series generation unit 112 is an example of a data series generation unit. The safety stock calculation unit 141 is an example of a safety stock calculation unit. The order quantity calculation unit 142 is an example of an order/production quantity calculation unit.

The present invention is not limited to the embodiments specifically disclosed above, but various modifications and improvements can be made within the scope of the present invention.

This application is based upon and claims the benefit of priority of the Japanese Priority Application No. 2014-169287 filed on Aug. 22, 2014, the entire contents of which are hereby incorporated by reference.

1. A stock management system, including a fluctuation value forecasting unit configured to output a future forecasting value from time series data of fluctuation values by using a plurality of ARIMA models, wherein the fluctuation value forecasting unit executes, a process b a CPU, to calculate the forecasting values for data series obtained for each of the ARIMA models, by
(1) defining multiple degree patterns of the model of the obtained data saris,
(2) estimating ARIMA parameters for each of the degree patterns,
(3) calculating an AICC and an error index for each of the degrees having the parameters determined,
(4) selecting an optimum degree pattern based on the AICCs and the error indices, and
(5) based on the ARIMA parameters of the selected degree pattern, using a predetermined formula, calculating forecasting value series and residual series to calculate the forecasting values, comprising:
a first forecasting unit configured to have the fluctuation value forecasting unit calculate, by the CPU, first forecasting values, by using the plurality of the ARIMA models, respectively, the ARIMA models being determined by using the time series data stored in a predetermined storage area;
an index value calculation unit configured to calculate, by the CPU, a first index value and a second index value, for each of the ARIMA models, by using the first forecasting values calculated by the first forecasting unit;
a model selection unit configured to select, by the CPU, one ARIMA model among the plurality of ARIMA models, based on the first index values and the second index values calculated by the index value calculation unit; and
a second forecasting unit configured to have the fluctuation value forecasting unit calculate, by the CPU, a second forecasting value as the future forecasting value of the time series data, by using the one ARIMA model selected by the model selection unit,
wherein the time series data is time series data of actual values representing sales quantities of predetermined goods,
wherein the first index value is a first average stock calculated by an accumulated error method, based on an error between the first forecasting value and the corresponding actual value in the time series data,
wherein the second index value is a second average stock calculated by an error adjustment method, based on an error between the first forecasting value and the corresponding actual value in the time series data, and a lead time of the goods.

2. The fluctuation value forecasting system, as claimed in claim 1, further comprising:
a data series generation unit configured to generate a plurality of data series having respective patterns, from the time series data,
wherein, for each of the plurality of data series generated by the data series generation unit, the first forecasting unit determines the ARIMA model corresponding to the data series, and has the fluctuation value forecasting unit calculate the first forecasting values, by using the ARIMA model.

3. The fluctuation value forecasting system, as claimed in claim 2, wherein the data series generation unit generates the data series including difference series of one or more patterns, and moving average series including one or more patterns, from the time series data.

4. The fluctuation value forecasting system, as claimed in claim 1, wherein the model selection unit selects the one ARIMA model among the plurality of ARIMA models, the one ARIMA model having a lowest value of the first index value or the second index value, among the first index values and the second index values of the plurality of ARIMA models.

5. (canceled)

6. The stock management system, as claimed in claim 5, further comprising:
a safety stock calculation unit configured to calculate a safety stock quantity representing a stock quantity with which no stockout is generated for the predetermined goods, based on the first forecasting value calculated by using the one of the ARIMA models selected by the model selection unit, the time series data, and a stockout ratio of the predetermined goods given in advance; and
an order/production quantity calculation unit configured to calculate a quantity for increasing or decreasing the stock quantity of the predetermined goods, based on the safety stock quantity calculated by the safety stock calculation unit, and the error between the second forecasting value and the actual value representing the sales quantity of the predetermined goods.

7. The stock management system, as claimed in claim 6, wherein the stockout ratio is a value input by a user, representing an allowable ratio for the user, with which the stockout is generated for the goods.

8. The stock management system, as claimed in claim 6, wherein the order/production quantity calculation unit calculates the quantity for increasing or decreasing the stock quantity of the predetermined goods so that the average stock quantity of the predetermined goods for a predetermined period is equivalent to the safety stock quantity.

9. A fluctuation value forecasting method, used for a fluctuation value forecasting system including a fluctuation value forecasting unit configured to output a future forecasting value from time series data of fluctuation values by using an ARIMA model, the method comprising:
a first forecasting step for having the fluctuation value forecasting unit calculate first forecasting values, with a CPU, by using a plurality of the ARIMA models, respectively, the ARIMA models being determined by using the time series data stored in a predetermined storage area;
an index value calculation step for calculating a first index value and a second index value, with the CPU, for each of the ARIMA models, by using the first forecasting values calculated by the first forecasting step;
a model selection step for selecting one ARIMA model among the plurality of ARIMA models, with the CPU, based on the first index values and the second index values calculated by the index value calculation step; and
a second forecasting step for having the fluctuation value forecasting unit calculate a second forecasting value as the future forecasting value of the time series data, with the CPU, by using the one ARIMA model selected by the model selection step,
wherein the time series data is time series data of actual values representing sales quantities of predetermined goods,
wherein the first index value is a first average stock calculated by an accumulated error method, based on an error between the first forecasting value and the corresponding actual value in the time series data,
wherein the second index value is a second average stock calculated by an error adjustment method, based on an error between the first forecasting value and the corresponding actual value in the time series data, and a lead time of the goods.

10. A non-transitory computer-readable recording medium having a program stored therein for causing a computer to execute a process of having the computer function as a fluctuation value forecasting system including a fluctuation value forecasting unit configured to output a future forecasting value from time series data of fluctuation values by using an ARIMA model, the process comprising:
a first forecasting step for having the fluctuation value forecasting unit calculate first forecasting values, by using a plurality of the ARIMA models, respectively, the ARIMA models being determined by using the time series data stored in a predetermined storage area;
an index value calculation step for calculating a first index value and a second index value, for each of the ARIMA models, by using the first forecasting values calculated by the first forecasting step;
a model selection step for selecting one ARIMA model among the plurality of ARIMA models, based on the first index values and the second index values calculated by the index value calculation step; and
a second forecasting step for having the fluctuation value forecasting unit calculate a second forecasting value as the future forecasting value of the time series data, by using the one ARIMA model selected by the model selection step,
wherein the time series data is time series data of actual values representing sales quantities of predetermined goods,
wherein the first index value is a first average stock calculated by an accumulated error method, based on an error between the first forecasting value and the corresponding actual value in the time series data,
wherein the second index value is a second average stock calculated by an error adjustment method, based on an error between the first forecasting value and the corresponding actual value in the time series data, and a lead time of the goods.
